(19) United States
(12) Patent Application Publication
(10) Pub. No.: US 2017/0113340 A1
(43) Pub. Date: Apr. 27, 2017

(54) Invertible Broom Handle Device

(71) Applicant: Shannon Tomasovich, Colchester, VT (US)

(72) Inventor: Shannon Tomasovich, Colchester, VT (US)

(21) Appl. No.: 14/923,559

(22) Filed: Oct. 27, 2015

(51) Int. Cl. B25G 1/06; B25G 3/36; A46B 5/02

(52) U.S. Cl. CPC B25G 1/06; A46B 5/026; B25G 3/36

(57) ABSTRACT

An invertible broom handle device allows inversion and connection of a broom handle to a broom head and grip when one end of the broom handle breaks. The device includes a broom head having a threaded aperture. A first end of a broom handle is externally threaded complementary to the threaded aperture. A second end of the broom handle is also externally threaded complementary to the threaded aperture wherein the first end and the second end are each threadingly engageable to the broom head. A grip is engageable to the broom handle by sliding the broom handle into an open end of the grip.

### BACKGROUND OF THE DISCLOSURE

### Field of the Disclosure

The disclosure relates to broom handle devices and more particularly pertains to a new broom handle device for allowing inversion and connection of a broom handle to a broom head and grip when one end of the broom handle breaks to provide a longer useful life for the broom handle.

### SUMMARY OF THE DISCLOSURE

An embodiment of the disclosure meets the needs presented above by generally comprising a broom head having a threaded aperture. A first end of a broom handle is externally threaded complementary to the threaded aperture. A second end of the broom handle is also externally threaded complementary to the threaded aperture wherein the first end and the second end are each threadingly engageable to the broom head. A grip is engageable to the broom handle by sliding the broom handle into an open end of the grip.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of an invertible broom handle device according to an embodiment of the disclosure.

FIG. 2 is an exploded top front side perspective view of an embodiment of the disclosure.

FIG. 3 is a detailed view of an embodiment of the disclosure shown in FIG. 2.

FIG. 4 is a cross-sectional view of an embodiment of the disclosure taken along the line 4-4 of FIG. 1.

FIG. 5 is a cross-sectional view of an embodiment of the disclosure similar to FIG. 4 but showing inversion of the broom handle after a break in the broom handle.

### DESCRIPTION OF THE PREFERRED EMBODIMENT

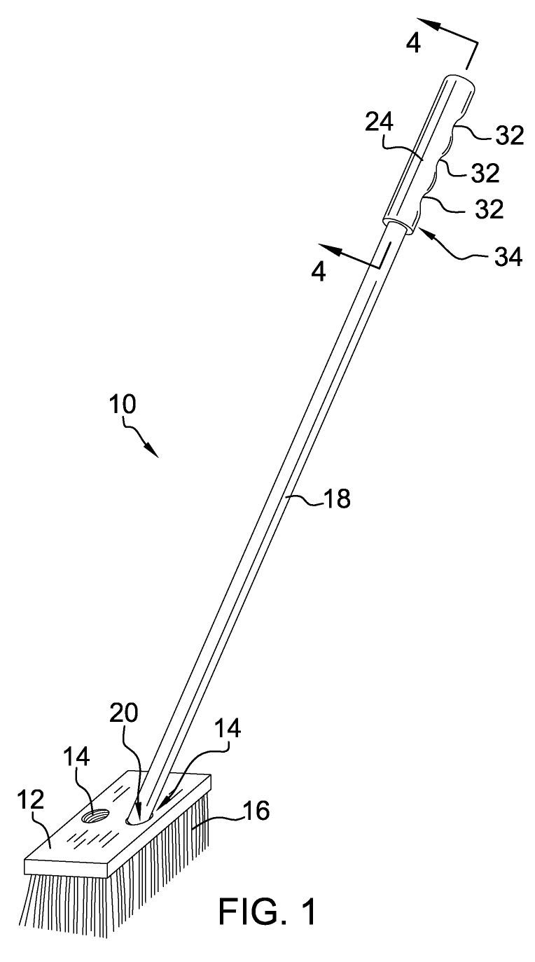

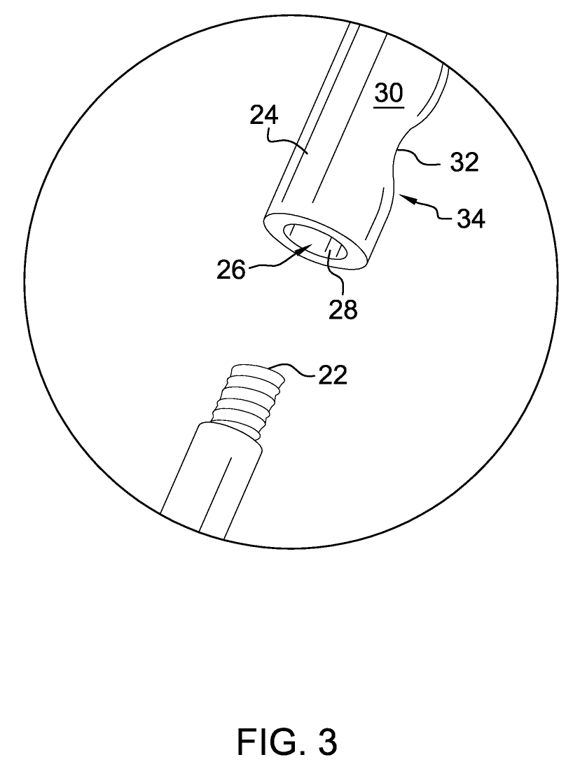

With reference now to the drawings, and in particular to FIGS. 1 through 5 thereof, a new broom handle device embodying the principles and concepts of an embodiment of the disclosure and generally designated by the reference numeral 10 will be described.

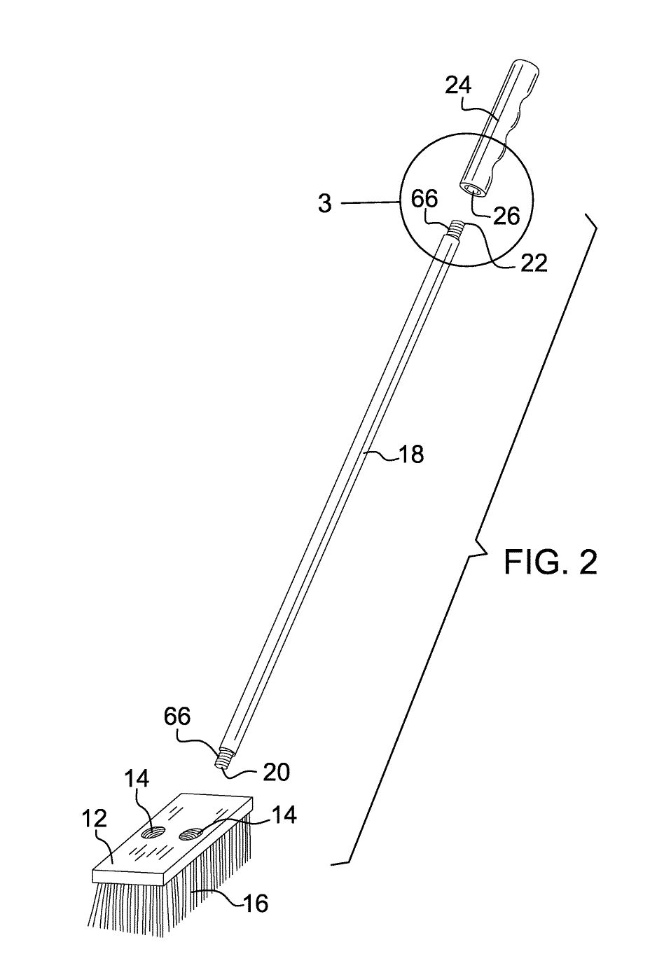

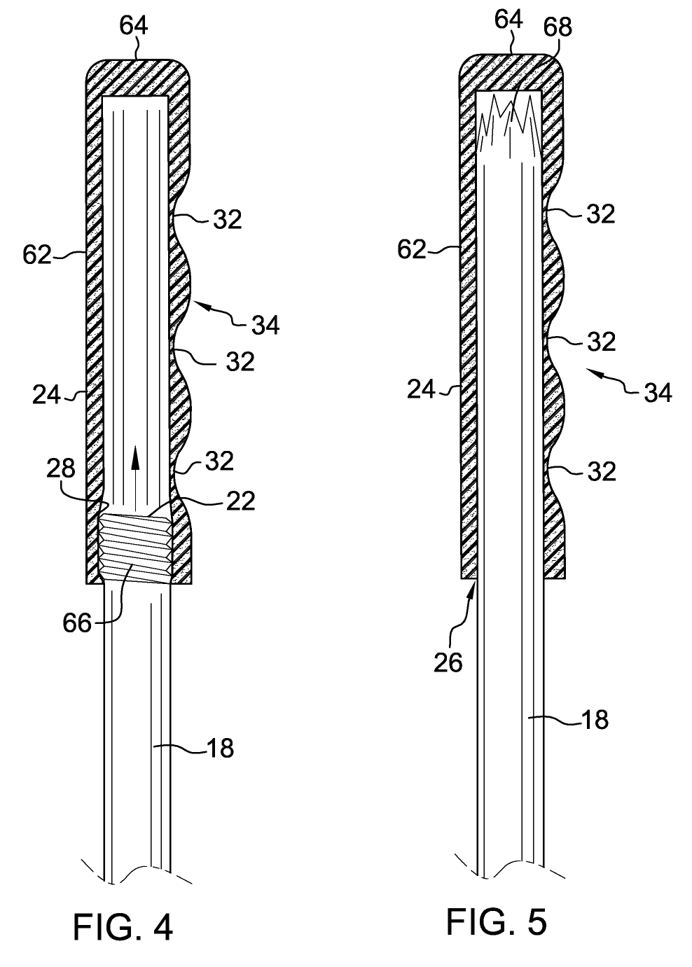

As best illustrated in FIGS. 1 through 5, the invertible broom handle device 10 generally comprises a broom head 12 having a threaded aperture 14. The broom head 12 is of conventional construction having bristles 16. The threaded aperture 14 may be one of a plurality of threaded apertures 14. A broom handle 18 has a first end 20 and a second end 22. The first end 20 is externally threaded complementary to the threaded aperture 14 wherein the first end 20 is threadingly engageable to the broom head 12. The second end 22 is similarly externally threaded complementary to the threaded aperture 14 wherein the second end 22 is threadingly engageable to the broom head 12 alternatively to coupling the first end 20 to the broom head 12. Threading 66 complementary to threaded aperture 14 may be inset on the first end 20 and second end 22, as exemplified in FIG. 2, or may extend outwardly from the broom handle 18, as shown in FIG. 4. Thus, the broom handle 18 may be inverted relative to the broom head 12 when desired.

A grip 24 has an open end 26 wherein the grip 24 is engageable to the broom handle 18 by sliding the broom handle 18 into the open end 26 of the grip 24. The grip 24 is constructed of a resiliently flexible material, such as rubber or the like, wherein the grip 24 is expanded by and frictionally engages the broom handle 18 when the broom handle 18 is inserted into the open end 26 of the grip 24. An inwardly facing surface 28 extending into the grip 24 from the open end 26 is smooth enhancing contact between the inwardly facing surface 28 and an outer surface 30 of the broom handle 18. Each of a plurality of finger grooves 32 extends into an exterior surface of the grip 24. Each of the finger grooves 32 is spaced along one side 34 of the grip 24.

In use, the first end 20 is engaged to the broom head 12 using the threaded aperture 14. Over time it is common for the broom handle 18 to break, particularly proximate the broom head 12. To extend the useful life of the broom handle 18, the grip 24 is removable from the broom handle 18 and a broken end 68 of the broom handle 18 is insertable into the grip 24. A butt end 64 of the grip 24 may be solid and thicker than a sidewall 62 of the grip 24 to inhibit the broken end 68 from piercing the butt end 64 of the grip 24. The first end 20 of the broom handle 18, now broken from the broom handle 18, is removable from the broom head 12. The second end 22 of the broom handle 18 is threadingly engageable to the broom head 12 using the threaded aperture 14 restoring a functional connection of the broom handle 18 to the broom head 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An invertible broom handle device comprising:
a broom head having a threaded aperture;
a broom handle having a first end and a second end, said first end being externally threaded complementary to said threaded aperture wherein said first end is threadingly engageable to said broom head, said second end being externally threaded complementary to said threaded aperture wherein said second end is threadingly engageable to said broom head; and
a grip, said grip having an open end wherein said grip is engageable to said broom handle by sliding said broom handle into said open end of said grip, an inwardly facing surface extending into said grip from said open end being smooth and defining a cylindrical void having a consistent diameter along a full length of said void.

2. (canceled)

3. The device of claim 1, further comprising a plurality of finger grooves extending into an exterior surface of said grip.

4. The device of claim 3, further comprising each of said finger grooves being spaced along one side of said grip.

5. The device of claim 1, further comprising said grip being constructed of a resiliently flexible material wherein said grip is expanded by and frictionally engages said broom handle when said broom handle is inserted into said open end of said grip.

6. An invertible broom handle device comprising:
a broom head having a threaded aperture;
a broom handle having a first end and a second end, said first end being externally threaded complementary to said threaded aperture wherein said first end is threadingly engageable to said broom head, said second end being externally threaded complementary to said threaded aperture wherein said second end is threadingly engageable to said broom head;
a grip, said grip having an open end wherein said grip is engageable to said broom handle by sliding said broom handle into said open end of said grip, said grip being constructed of a resiliently flexible material wherein said grip is expanded by and frictionally engages said broom handle when said broom handle is inserted into said open end of said grip;
an inwardly facing surface extending into said grip from said open end being smooth and defining a cylindrical void having a consistent diameter along a full length of said void; and
a plurality of finger grooves extending into an exterior surface of said grip, each of said finger grooves being spaced along one side of said grip.
